(19) United States
(12) Patent Application Publication
(10) Pub. No.: US 2006/0260396 A1
(43) Pub. Date: Nov. 23, 2006

(54) Peak Velocity Detector

(76) Inventor: Robert Franklin Van Cott, Mount Sinai, NY (US)

Correspondence Address: ROBERT VAN COTT, 21 PEACH TREE LANE, MOUNT SINAI, NY, 11766, US

(21) Appl. No.: 11/308,836

(22) Filed: May 12, 2006

Related U.S. Application Data
(60) Provisional application No. 60/681,803, filed on May 18, 2005.

(51) Int. Cl. G01P 15/00

(52) U.S. Cl. 73/488

(57) ABSTRACT

A device that provides an output at the instant that peak velocity is reached. It is comprised of two main components, namely an acceleration detection switch connected in series with another acceleration detection switch.

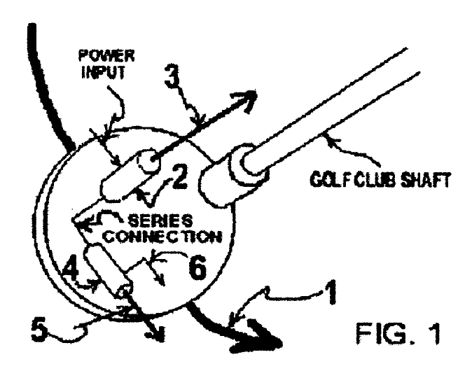

FIG. 1 depicts the peak velocity detector mounted on a golf club shaft. It can be mounted on any item that will move along a curved path 1. Switch A 2, is mounted so that its acceleration sensing axis is in alignment with the centripetal acceleration 3 experienced from motion along a curved path 1. Switch B 4, which is in series with switch A 2, is oriented such that it will sense the reversal of the tangential acceleration 5 which occurs at the instant that peak velocity occurs. The output 6 from switch B 4 at peak velocity can be used as an input to a computer for processing purposes or to a visual indicator.

Using the golf swing as an example, during the downswing, prior to peak velocity, switch A 2 is “on” and provides an output continuously to switch B 4 due to the centripetal acceleration 3 that is above a predetermined magnitude acting on switch A 2 due to motion along the curved path 1. As peak velocity is approached, switch A 2 continues to provide an output to switch B 4 which, up to this time, is “off” and provides no output due to the tangential acceleration 5 acting on its acceleration sensing axis. At peak velocity, switch A 2 continues to provide an output to switch B 4 which is “on” and now provides an output 6 because the tangential acceleration 5 reversed direction. The series circuit is now complete at peak velocity, thereby causing the output 6 from the peak velocity detector at switch B 4.

What is claimed is:

1. A peak velocity detector, comprising:
an acceleration sensing switch, hereby designated as (switch A), that is “off” while an acceleration below a predetermined magnitude is sensed along its acceleration sensing axis or “on” while an acceleration at or above the predetermined magnitude is sensed along its acceleration sensing axis and
a second acceleration sensing switch, hereby designated as (switch B), that switches from “off” to “on” at the instant when an acceleration sensed along its acceleration sensing axis reverses direction.

2. A peak velocity detector as recited in claim 1, wherein said (switch A) is functionally connected in series to said (switch B).

3. A peak velocity detector as recited in claim 2, wherein the said (switch A) acceleration sensing axis is oriented orthogonal to the said (switch B) acceleration sensing axis.

4. A peak velocity detector as recited in claim 3, wherein said (switch B) provides an output from the instant that peak velocity occurs.
